(19) United States
(12) Patent Application Publication
(10) Pub. No.: US 2024/0086224 A1
(43) Pub. Date: Mar. 14, 2024

(54) WORKLOAD PLACEMENT BASED ON DATASTORE CONNECTIVITY GROUP

(71) Applicant: VMWARE,INC., Palo Alto, CA (US)

(72) Inventors: SAHAN BAMUNAVITA GAMAGE, Palo Alto, CA (US); BING HU, Santa clara, CA (US); NARENDRA MADANAPALLI, Bangalore (IN); PRANSHU JAIN, Palo Alto, CA (US); MAARTEN WIGGERS, San Francisco, CA (US)

(21) Appl. No.: 18/244,926

(22) Filed: Sep. 12, 2023

(30) Foreign Application Priority Data
Sep. 13, 2022 (IN) 202241052372

(51) Int. Cl. G06F 9/455; G06F 9/50

(52) U.S. Cl. CPC G06F 9/45558; G06F 9/5055; G06F 2009/45562

(57) ABSTRACT

The present disclosure relates to workload placement based on datastore connectivity group. Some embodiments include separating a cluster having a plurality of hosts and a plurality of datastores into a plurality of datastore connectivity groups (DCGs), wherein the hosts and the datastores of each cluster are fully connected, for each DCG, executing distributed resource scheduler (DRS) to determine a best host and executing storage DRS to determine a best datastore, and executing a workload placement program to determine a best host-datastore pair from among the plurality of DCGs.

### RELATED APPLICATIONS

Benefit is claimed under 35 U.S.C. 119(a)-(d) to Foreign Application Serial No. 202241052372 filed in India entitled “WORKLOAD PLACEMENT BASED ON DATASTORE CONNECTIVITY GROUP”, on Sep. 13, 2022, by VMware, Inc., which is herein incorporated in its entirety by reference for all purposes.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for workload placement based on datastore connectivity group according to one or more embodiments of the present disclosure.

FIG. 2 illustrates a plurality of hosts and datastores according to one or more embodiments of the present disclosure.

FIG. 3 illustrates a DCG with 64 hosts, 16 shared datastores, and 1 local datastore per host according to one or more embodiments of the present disclosure.

FIG. 4 illustrates a DCG with 64 hosts, 16 shared datastores, and 32 local datastores according to one or more embodiments of the present disclosure.

FIG. 5 is a diagram of a system for workload placement based on datastore connectivity group according to one or more embodiments of the present disclosure.

FIG. 6 is a diagram of a machine for workload placement based on datastore connectivity group according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

When a workload (e.g., a VCI) is created, it is placed on some host (by vSphere Distributed Resource Scheduler (DRS)) and on some datastore (by vSphere Storage DRS). A host-datastore connectivity constraint is that the host recommended by DRS must be able to access the datastore recommended by Storage DRS.

Because of above connectivity constraint, a workload placement algorithm (e.g., xDRS) may do a time complexity (e.g., a worst case complexity) of O(M*N) selection to get the best pair of <host, datastores> among all <host, datastore> combinations, where M is the number of hosts in the vCenter cluster, and N is the number of datastores that are connected to the cluster.

Due to high O(M*N) complexity, previous xDRS algorithms may not seek to find the best pair of <host, datastore>. Instead, such algorithms seek to find the best datastore among N datastores, and then recommend the best host among the hosts which are connected to the best datastore. The time complexity is O(M+N), but it will not return the target (e.g., optimal)<host, datastore> pair.

Embodiments of the present disclosure can reduce the O(M*N) time-complexity of xDRS placement algorithm and still return the optimal <host, datastore> pair. For example, some embodiments include a concept referred to herein as “Datastore Connectivity Group” (DCG). Embodiments herein include breaking down the single vCenter cluster with M hosts and N datastores (which may not be fully connected) into a few DCGs. In each DCG, the hosts and datastores are fully connected. Therefore, in each DCG, there is no host-datastore connectivity constraint.

In some embodiments, for instance, an xDRS placement algorithm performs two steps based on the new DCG construction. First, in each DCG, run DRS to get the best host and run Storage DRS to get the best datastore. Due to the fully-connected property of DCG, the best host and best datastore are connected (e.g., are guaranteed to be connected). Second, xDRS (e.g., the execution of a set of workload placement instructions) returns the best pair of <host, datastore> among all DCGs.

To place a VCI in single DCG, the algorithm complexity is O(m+n), where m is the number of hosts and n is the number of datastores in the cluster. To cover all DCGs, the overall algorithm complexity is O(M+N).

Previous approaches include two existing solutions to get the recommended <host, datastore> pair for xDRS placement. However, none of these approaches could return the optimal <host, datastore> with time complexity of O(M+N). One previous approach includes getting the recommended datastore by Storage DRS, and then recommending host by DRS which could access the recommended datastore. If DRS could not find an available host, the SDRS process is repeated with a different datastore. Another previous approach includes getting the recommended host by DRS, and getting the recommended datastores by SDRS that could be accessed by the recommended host. If SDRS could not find available datastores, the DRS process is repeated with a different host. Both of these approaches are inadequate. For instance, both could not find the best <host, datastore> pair among all <host, datastore> combinations since they either find the best datastores without knowing whether the recommend host is the best, or they find the best host without knowing whether connected datastores are the best. Additionally, both need to run algorithm with time complexity of O(M*N) to get the best <host, datastores> pair.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

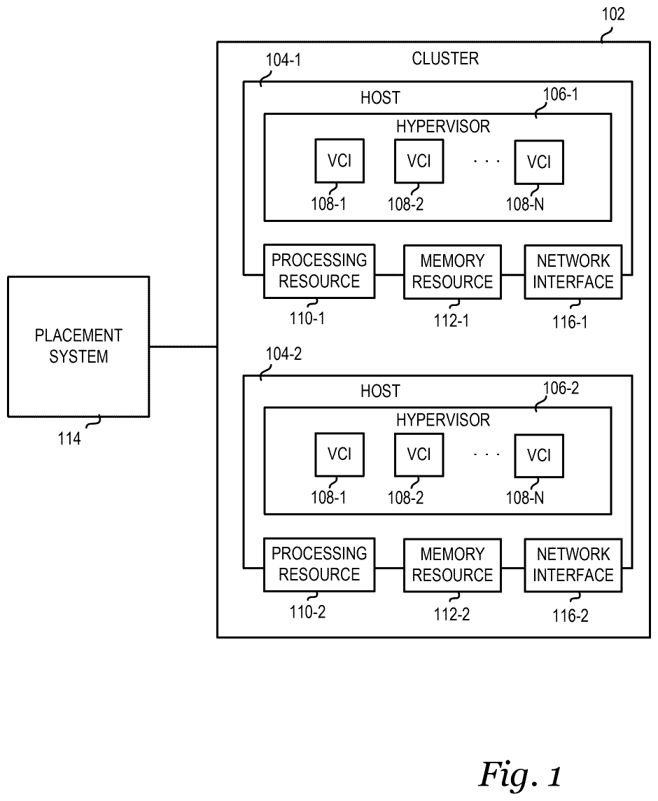

The figures herein follow a numbering convention in which the first digit or digits correspond to the drawing figure number and the remaining digits identify an element or component in the drawing. Analogous elements within a Figure may be referenced with a hyphen and extra numeral or letter. Such analogous elements may be generally referenced without the hyphen and extra numeral or letter. For example, elements 108-1, 108-2, and 108-N in FIG. 1 may be collectively referenced as 108. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a diagram of a host and a system for workload placement based on datastore connectivity group according to one or more embodiments of the present disclosure. The system can include a cluster 102 in communication with a placement system 114. The cluster 102 can include a first host 104-1 with processing resources 110-1 (e.g., a number of processors), memory resources 112-1, and/or a network interface 116-1. Similarly, the cluster 102 can include a second host 104-2 with processing resources 110-2, memory resources 112-2, and/or a network interface 116-2. Though two hosts are shown in FIG. 1 for purposes of illustration, embodiments of the present disclosure are not limited to a particular number of hosts. For purposes of clarity, the first host 104-1 and/or the second host 104-2 (and/or additional hosts not illustrated in FIG. 1) may be generally referred to as “host 104.” Similarly, reference is made to “hypervisor 106,” “VCI 108,” “processing resources 110,” memory resources 112,” and “network interface 116,” and such usage is not to be taken in a limiting sense.

The host 104 can be included in a software-defined data center. A software-defined data center can extend virtualization concepts such as abstraction, pooling, and automation to data center resources and services to provide information technology as a service (ITaaS). In a software-defined data center, infrastructure, such as networking, processing, and security, can be virtualized and delivered as a service. A software-defined data center can include software-defined networking and/or software-defined storage. In some embodiments, components of a software-defined data center can be provisioned, operated, and/or managed through an application programming interface (API).

The host 104-1 can incorporate a hypervisor 106-1 that can execute a number of VCIs 108-1, 108-2, . . . , 108-N(referred to generally herein as “VCIs 108”). Likewise, the host 104-2 can incorporate a hypervisor 106-2 that can execute a number of VCIs 108. The hypervisor 106-1 and the hypervisor 106-2 are referred to generally herein as a hypervisor 106. The VCIs 108 can be provisioned with processing resources 110 and/or memory resources 112 and can communicate via the network interface 116. The processing resources 110 and the memory resources 112 provisioned to the VCIs 108 can be local and/or remote to the host 104. For example, in a software-defined data center, the VCIs 108 can be provisioned with resources that are generally available to the software-defined data center and not tied to any particular hardware device. By way of example, the memory resources 112 can include volatile and/or non-volatile memory available to the VCIs 108. The VCIs 108 can be moved to different hosts (not specifically illustrated), such that a different hypervisor manages (e.g., executes) the VCIs 108. The host 104 can be in communication with the placement system 114. In some embodiments, the placement system 114 can be deployed on a server, such as a web server.

The placement system 114 can include computing resources (e.g., processing resources and/or memory resources in the form of hardware, circuitry, and/or logic, etc.) to perform various operations, as described in more detail herein.

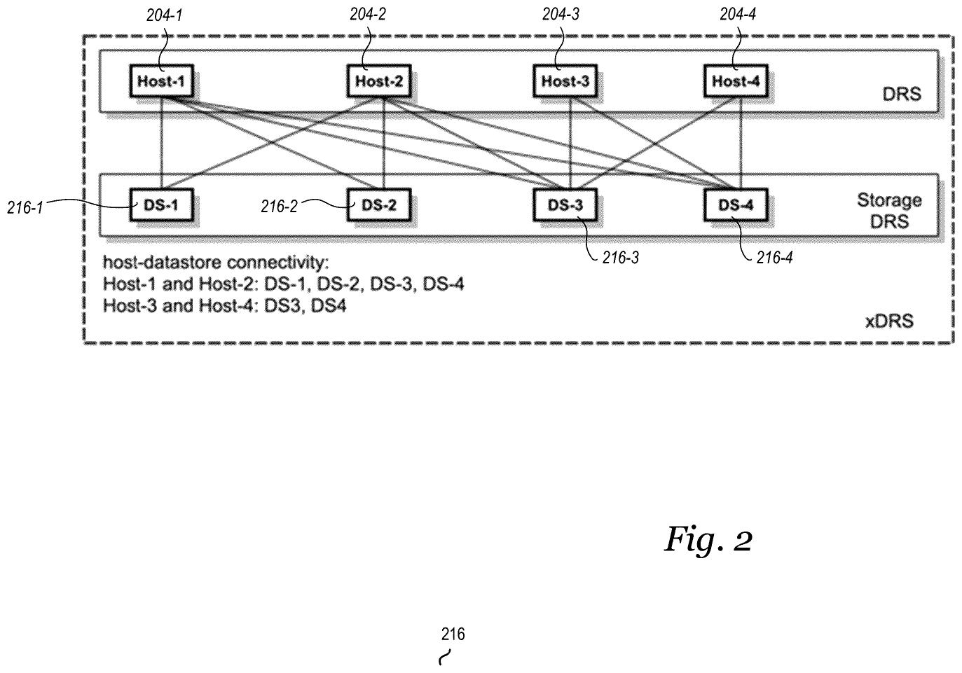

FIG. 2 illustrates a plurality of hosts and datastores according to one or more embodiments of the present disclosure. xDRS can perform both host and datastore recommendation. For VCI placement, xDRS utilizes DRS to find the best host and Storage DRS to find the best datastore. Then, xDRS combines the recommended host and datastore with a constraint that the host and datastore are connected. Because of the connectivity constraint, it is a selection problem to find the best pair of <host, datastore> among a list of hosts and datastores as illustrated in FIG. 2. As shown, host-1 204-1 and host-2 204-2 are each connected to DS-1 216-1, DS-2 216-2, DS-3 216-3, and DS-4 216-4. Host-3 204-3 and host-4 204-4 are each connected to DS-3 216-3 and DS-4 216-4.

If hosts and datastores are fully connected, it is a O(#hosts+#datastores) problem; DRS can be run once to get the best host and SDRS can be run once to get the best datastore. The pair of <bestHost, bestDatastore> is the answer for xDRS since it can be guaranteed that bestHost is connected to bestDatastore in a fully connected system. If hosts and datastores are not fully connected, xDRS runs SDRS to get all compatible datastores and run DRS to get all compatible hosts, and then do a O(M*N) selection for best pair of <host, datastores>. It is noted that M is number of #hosts, and N is number of #datastores.

Embodiments of the present disclosure can break down the single vCenter cluster with M hosts and N datastores (which may not be fully connected) into a few DCGs. In each DCG, the hosts and datastores are fully connected. Therefore, in each DCG, there is no host-datastore connectivity constraint. A DCG, as referred to herein, is the maximal set of hosts such that each host in the set is connected to the same datastores as any other hosts in the set. Hosts that are not connected to any datastore form their own DCG.

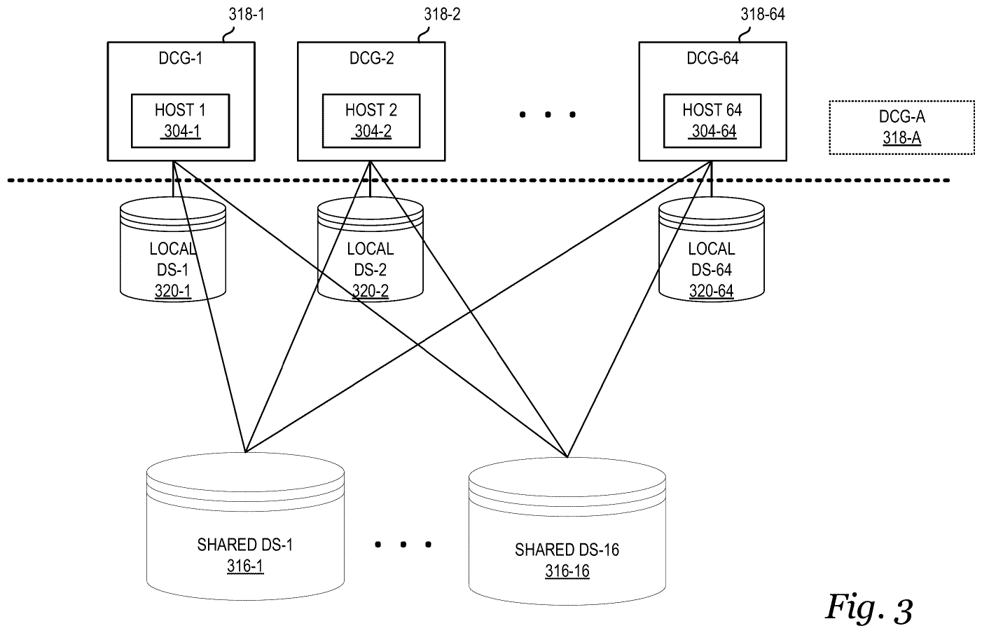

FIG. 3 illustrates a DCG with 64 hosts, 16 shared datastores, and 1 local datastore per host according to one or more embodiments of the present disclosure. If only considering shared datastores (e.g., shared DS-1 316-1 and shared DS-16 316-16) for workload placement, a single connectivity-group (DCG-A 318-A) is built. The single DCG-A 318-A group has 64 hosts+16 shared datastores. If local datastores (e.g., local DS-1 320-1, local DS-2 320-2, local DS-64) are also considered for workload placement, 64 connectivity-groups (DCG-[1-64] 318-[1-64]) are built, where each group has a single host with 1 local datastore+16 shared datastores.

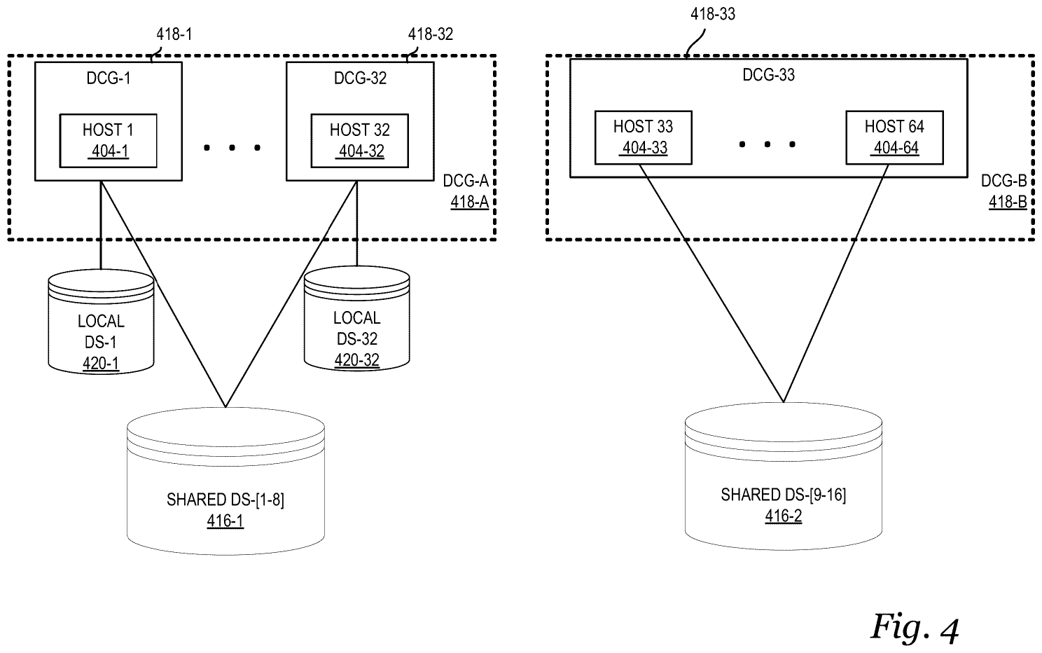

FIG. 4 illustrates a DCG with 64 hosts, 16 shared datastores, and 32 local datastores according to one or more embodiments of the present disclosure. The topology illustrated in FIG. 4 includes 64 hosts. Inside 64 hosts, 32 hosts (e.g., host 404-33 through host 404-64) are fully connected to 8 shared datastores (shared DS-[1-8] 416-1). The other 32 hosts (e.g., host 404-1 through host 404-32) are also fully connected to the other 8 shared datastores (shared DS-[9-16] 416-1), and each host also has one local datastore (e.g., local DS-1 420-1 and local DS-32 420-32).

If only considering shared datastores for workload placement, two connectivity-groups (DCG-A 418-A and DCG-B 418-B) are built. The two groups are: <32 hosts+8 shared datastores> and <32 hosts+8 shared datastores>. If local datastores are also considered for workload placement, 32 connectivity-groups (DCG-[1-32]) are built where each group is <1 host+1 local datastore+8 shared datastores>, and 1 connectivity-group (DCG-33) is built with <32 hosts+8 shared datastores>. In total, 33 connectivity-groups are built.

The xDRS placement algorithm can perform two steps based on the new DCG construction. First, in each DCG, run DRS to get the best host and run Storage DRS to get the best datastore. Due to fully connected property of DCG, the best host and best datastore is guaranteed to be connected. Second, xDRS returns the best pair of <host, datastore> among all DCGs. To place a VCI in single DCG, the algorithm complexity is 0(m+n), m is the number of hosts and n is the number of datastores in the cluster. To cover all DCG groups, the overall algorithm complexity is O(M+N).

DCG is an equivalence relation and partitions a set of hosts. It has a number of properties. One property is that hosts in DCGs are a disjoint set, but datastores in DCGs are not. Another property is that hosts and datastores in each DCG are fully connected. Another property is that combined placement (xDRS) on DCGs is guaranteed to return a successful placement if there is a feasible one (correctness). Another property is that combined placement (xDRS) on DCGs cannot return a successful placement if there is no feasible one (correctness). Another property is that combined placement (xDRS) on DCGs is guaranteed to find the best host and best datastores (optimal solution). Another property is that combined placement (xDRS) run-time complexity with DCGs is same as or better than brute-force, or host-first, or datastore-first approach (optimal performance).

The DCG-based xDRS algorithm can, in some embodiments, guarantee the best “combination” of host and datastore. In other words, without DCGs, other xDRS algorithms, previously discussed, would have either preferred to select the “best host and any of the best datastores only among the datastores connected to the best host” or it would have preferred to select “the best datastore and the best host only among the hosts connected to the best datastore.” Instead, embodiments of the present disclosure allow selecting a “balanced combination.” For example, the “best host” and the “best datastore” may not be connected but it may be possible that the “second best host and the “second best datastore” are connected.

It can be proved that every host is in a group, and that no host is in any two groups. The datastores could be in different groups. In other words, every host must be in one and only one DCG; every datastore must be in one or more DCGs depending on host-datastore connectivity topology. Every host is in a group because either the host has a connected datastore and is part of a DCG or the host does not have a connected datastore and forms its own DCG. To prove that no host is in two partitions, suppose a host h1 would not have a unique DCG, then there are at least two sets of hosts: D1 and D2. In this example, h1 has the same connected datastores as all other hosts in D1, and h1 has the same connected datastores as all other hosts in D2. This implies that all hosts in D1 are connected to the same datastores as all hosts in D2, and that D1 and D2 are the same DCG. It can be concluded that it is not possible for a host to be part of two DCGs. Connectivity topology {h1: ds1+ds2, h2: ds1+ds2, h3: d1+d2} would form two DCG groups of {h1+h2: ds1, ds2} and {h3: ds1, ds2, ds3}. Both ds1 and ds2 are shared in the two groups.

In a scenario with fully connected hosts and datastores, if h1 in D1 only connects to part of datastores in D1, based on DCG definition, then h1 would form a new (or join an existing) DCG D2 which includes and only includes h1's connected datastores. The process would repeat until all hosts in D1 are connected to the same datastores. Then D1 is fully connected and D2 is also fully connected.

Placement on DCGs is a successful placement if there is a possible one. When xDRS runs through all DCGs, it evaluates all hosts and datastores in DCGs. If DCGs cover all hosts or datastores from input, then DCG-based placement would not miss any successful placement. As previously discussed, every host is in some group, so all DCGs are inclusive for all hosts. Since any accessible datastore must be connected to one or more hosts, either a datastore is not accessible (e.g., invalid placement) or the datastore is part of some DCG. Accordingly, all DCGs cover all hosts and accessible datastores. If xDRS placement goes through all DCGs, the placement would be found if there is a successful one. Any final <host, datastore> selection from any DCG would go through DRS for host selection, and through Storage DRS for datastore selection. If there is no feasible solution, it means that there is no compatible host, no compatible datastore, and/or a compatible host and data store are not connected. DRS/SDRS inside DCG would catch either of the first two cases. For the third, a not connected host and datastore would be in different DCGs, and xDRS would not return any recommendation spanning DCGs. As previously discussed, every host/datastore is in some group. If xDRS placement goes through all DCGs, it could get the best host and datastores among all hosts and datastores.

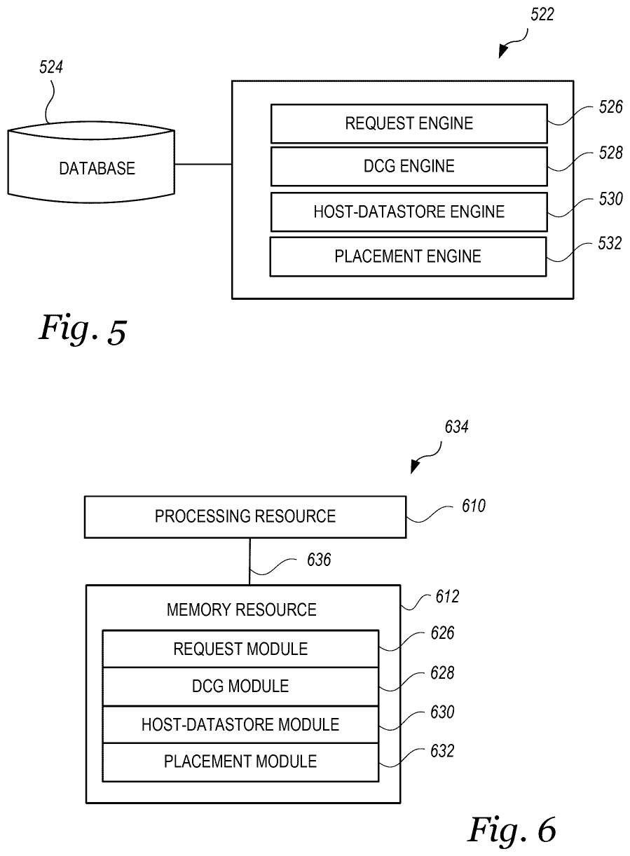

FIG. 5 is a diagram of a system 522 for workload placement based on datastore connectivity group according to one or more embodiments of the present disclosure. The system 522 can include a database 646 and/or a number of engines, for example interface engine 648 and/or creation engine 650, and can be in communication with the database 646 via a communication link. The system 522 can include additional or fewer engines than illustrated to perform the various functions described herein. The system can represent program instructions and/or hardware of a machine (e.g., machine 634 as referenced in FIG. 6, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the request engine 526 can include a combination of hardware and program instructions that is configured to receive a request to place a virtual computing instance (VCI) in a cluster that includes a plurality of hosts and a plurality of datastores. In some embodiments, the DCG engine 528 can include a combination of hardware and program instructions that is configured to define a plurality of datastore connectivity groups (DCGs) within the cluster, wherein, in each DCG, each host is fully connected and each datastore is fully connected. In some embodiments, the host-datastore engine 530 can include a combination of hardware and program instructions that is configured to determine a respective suitable host for each of the plurality of DCGs and determine a respective suitable datastore for each of the plurality of DCGs. In some embodiments, the placement engine 532 can include a combination of hardware and program instructions that is configured to determine a placement host and a placement datastore from among the respective suitable hosts and the respective suitable datastores.

FIG. 6 is a diagram of a machine for workload placement based on datastore connectivity group according to one or more embodiments of the present disclosure. The machine 634 can utilize software, hardware, firmware, and/or logic to perform a number of functions. The machine 634 can be a combination of hardware and program instructions configured to perform a number of functions (e.g., actions). The hardware, for example, can include a number of processing resources 610 and a number of memory resources 612, such as a machine-readable medium (MRM) or other memory resources 612. The memory resources 612 can be internal and/or external to the machine 634 (e.g., the machine 634 can include internal memory resources and have access to external memory resources). In some embodiments, the machine 634 can be a virtual computing instance (VCI). The program instructions (e.g., machine-readable instructions (MRI)) can include instructions stored on the MRM to implement a particular function (e.g., an action such as configuring a certificate, as described herein). The set of MRI can be executable by one or more of the processing resources 610. The memory resources 612 can be coupled to the machine 634 in a wired and/or wireless manner. For example, the memory resources 612 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 612 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 610 can be coupled to the memory resources 612 via a communication path 636. The communication path 636 can be local or remote to the machine 634. Examples of a local communication path 636 can include an electronic bus internal to a machine, where the memory resources 612 are in communication with the processing resources 610 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 636 can be such that the memory resources 612 are remote from the processing resources 610, such as in a network connection between the memory resources 612 and the processing resources 610. That is, the communication path 636 can be a network connection. Examples of such a network connection can include a local area network (LAN), wide area network (WAN), personal area network (PAN), and the Internet, among others.

As shown in FIG. 6, the MRI stored in the memory resources 612 can be segmented into a number of modules 626, 628, 630, 632 that when executed by the processing resources 610 can perform a number of functions. As used herein a module includes a set of instructions included to perform a particular task or action. The number of modules 626, 628, 630, 632 can be sub-modules of other modules. For example, the host-datastore module 630 can be a sub-module of the DCG module 628 and/or can be contained within a single module. Furthermore, the number of modules 626, 628, 630, 632 can comprise individual modules separate and distinct from one another. Examples are not limited to the specific modules 626, 628, 630, 632 illustrated in FIG. 6.

Each of the number of modules 626, 628, 630, 632 can include program instructions and/or a combination of hardware and program instructions that, when executed by a processing resource 610, can function as a corresponding engine as described with respect to FIG. 5. For example, the request module 626 can include program instructions and/or a combination of hardware and program instructions that, when executed by a processing resource 610, can function as the request engine 526, though embodiments of the present disclosure are not so limited.

The machine 634 can include a request module 626, which can include instructions to receive a request to place a virtual computing instance (VCI) in a cluster that includes a plurality of hosts and a plurality of datastores. The machine 634 can include a DCG module 628, which can include instructions to define a plurality of datastore connectivity groups (DCGs) within the cluster. In each DCG, each host is fully connected and each datastore is fully connected. The machine 634 can include a host-datastore module 630, which can include instructions to, for each of the plurality of DCGs, determine a respective suitable host and determine a respective suitable datastore. The machine 634 can include a placement module 632, which can include instructions to determine a placement host and a placement datastore from among the respective suitable hosts and the respective suitable datastores.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving a request to place a virtual computing instance (VCI) in a cluster that includes a plurality of hosts and a plurality of datastores;
defining a plurality of datastore connectivity groups (DCGs) within the cluster, wherein, in each DCG, each host is fully connected and each datastore is fully connected;
determining a respective suitable host within each of the plurality of DCGs;
determining a respective suitable datastore within each of the plurality of DCGs; and
determining a placement host and a placement datastore from among the respective suitable hosts and the respective suitable datastores.

2. The method of claim 1, wherein the method includes placing the VCI with the placement host and the placement datastore.

3. The method of claim 1, wherein the method includes executing a distributed resource scheduler (DRS) to determine the respective suitable host within each of the plurality of DCGs.

4. The method of claim 1, wherein the method includes executing a storage DRS to determine the respective suitable datastore within each of the plurality of DCGs.

5. The method of claim 1, wherein the method includes executing a set of workload placement instructions to determine the placement host and the placement datastore from among the respective suitable hosts and the respective suitable datastores.

6. The method of claim 1, wherein, for any of the plurality of DCGs, each host of the DCG is connected to a same set of datastores in the DCG as any other host in the DCG.

7. The method of claim 1, wherein defining the plurality of DCGs includes defining a DCG including a host that is not connected to any datastore.

8. A non-transitory machine-readable medium having instructions stored thereon which, when executed by a processor, cause the processor to:
receive a request to place a virtual computing instance (VCI) in a cluster that includes a plurality of hosts and a plurality of datastores;
define a plurality of datastore connectivity groups (DCGs) within the cluster, wherein, in each DCG, each host is fully connected and each datastore is fully connected;
for each of the plurality of DCGs:
determine a respective suitable host; and
determine a respective suitable datastore; and
determine a placement host and a placement datastore from among the respective suitable hosts and the respective suitable datastores.

9. The medium of claim 8, including instructions to place the VCI with the placement host and the placement datastore.

10. The medium of claim 8, including instructions to execute a distributed resource scheduler (DRS) to determine the respective suitable host within each of the plurality of DCGs.

11. The medium of claim 8, including instructions to execute a storage DRS to determine the respective suitable datastore within each of the plurality of DCGs.

12. The medium of claim 8, including instructions to execute a set of workload placement instructions to determine the placement host and the placement datastore from among the respective suitable hosts and the respective suitable datastores.

13. The medium of claim 8, wherein, for any of the plurality of DCGs, each host of the DCG is connected to a same set of datastores in the DCG as any other host in the DCG.

14. The medium of claim 8, wherein the instructions to define the plurality of DCGs include instructions to define a DCG including a host that is not connected to any datastore.

15. A system, comprising:
a request engine configured to receive a request to place a virtual computing instance (VCI) in a cluster that includes a plurality of hosts and a plurality of datastores;
a DCG engine configured to define a plurality of datastore connectivity groups (DCGs) within the cluster, wherein, in each DCG, each host is fully connected and each datastore is fully connected;
a host-datastore engine configured to, for each of the plurality of DCGs:
determine a respective suitable host; and
determine a respective suitable datastore; and
a placement engine configured to determine a placement host and a placement datastore from among the respective suitable hosts and the respective suitable datastores.

16. The system of claim 15, wherein the placement engine is configured to place the VCI with the placement host and the placement datastore.

17. The system of claim 15, wherein the host-datastore engine is configured to execute a distributed resource scheduler (DRS) to determine the respective suitable host within each of the plurality of DCGs.

18. The system of claim 15, wherein the host-datastore engine is configured to execute a storage DRS to determine the respective suitable datastore within each of the plurality of DCGs.

19. The system of claim 15, wherein the placement engine is configured to execute a set of workload placement instructions to determine the placement host and the placement datastore from among the respective suitable hosts and the respective suitable datastores.

20. The system of claim 15, wherein the DCG engine is configured to define a DCG including a host that is not connected to any datastore.
